(19) United States
(12) Patent Application Publication
(10) Pub. No.: US 2026/0068824 A1
(43) Pub. Date: Mar. 12, 2026

(54) HEDGE TRIMMER

(71) Applicant: Milwaukee Electric Tool Corporation, Brookfield, WI (US)

(72) Inventors: Dylan J. Konop, Brookfield, WI (US); Michael S. Van Dyke, Wauwatosa, WI (US); Peter Davies, Brookfield, WI (US); Travis Leathrum, Brookfield, WI (US); Hunter Kollman, Brookfield, WI (US); Coby Nettleton, Brookfield, WI (US); Richard A. Behnke, Milwaukee, WI (US); Adam F. Czerwonka, Mukwonago, WI (US); Beth E. Cholst, Wauwatosa, WI (US)

(21) Appl. No.: 19/306,553

(22) Filed: Aug. 21, 2025

Related U.S. Application Data
(60) Provisional application No. 63/692,311, filed on Sep. 9, 2024.

(51) Int. Cl. A01G 3/053; A01G 3/04

(52) U.S. Cl. CPC A01G 3/053; A01G 2003/0461

(57) ABSTRACT

An outdoor power tool and methods of operating outdoor power tools are provided. An outdoor power tool includes a first blade extending from a first end to a second end, a second blade extending from the first end to the second end, a first connecting rod coupled to the first blade at the first end and comprising a first length, a second connecting rod coupled to the second blade at the first end and comprising a second length different from the first length, and a crankshaft coupled to the first connecting rod and the second connecting rod. The crankshaft is configured for transmitting reciprocating motion to the first blade, the second blade, or both the first blade and the second blade in a first direction and a second direction. The second direction is opposite the first direction.

### CROSS-REFERENCE TO RELATED APPLICATIONS

This application claims priority to U.S. Provisional Patent Application No. 63/692,311, filed Sep. 9, 2024, the entire contents of which are incorporated herein by reference.

### FIELD

The present disclosure relates generally to outdoor power tools, and more particularly to hedge trimmers and hedge trimmers with blade change systems.

### BACKGROUND

Outdoor tools, such as hedge trimmers, are used for performing outdoor tasks, such as trimming hedges. Such hedge trimmers include a set of blades that cut through objects or materials based on reciprocating motion. The blades may periodically need to be replaced by an operator of the hedge trimmer. Removal and replacement of the blades may be time consuming and difficult for some operators.

Accordingly, improved outdoor tools, including hedge trimmers, are desired in the art. In particular, hedge trimmers with improved blade replacement and detection capabilities would be advantageous.

### BRIEF DESCRIPTION

Aspects and advantages of the present disclosure will be set forth in part in the following description, or may be obvious from the description, or may be learned through practice of the technology.

In accordance with one embodiment, an outdoor power tool is provided. The outdoor power tool includes a first blade extending from a first end to a second end, a second blade extending from the first end to the second end, a first connecting rod coupled to the first blade at the first end and comprising a first length, a second connecting rod coupled to the second blade at the first end and comprising a second length different from the first length, and a crankshaft coupled to the first connecting rod and the second connecting rod. The crankshaft is configured for transmitting reciprocating motion to the first blade, the second blade, or both the first blade and the second blade in a first direction and a second direction. The second direction is opposite the first direction.

In accordance with another embodiment, a method of operating an outdoor power tool is provided. The method includes providing a housing including a motor and a crankshaft coupled to the motor, coupling a blade unit including a first blade and a second blade to the crankshaft, determining a blade type of the first blade and the second blade, and operating the motor based on the blade type.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1A is a perspective view of a hedge trimmer in accordance with embodiments of the present disclosure;

FIG. 1B is a perspective view of another hedge trimmer in accordance with embodiments of the present disclosure;

FIG. 2 is a perspective view of a blade assembly of the hedge trimmer in accordance with embodiments of the present disclosure;

FIG. 3 is a perspective view of an assembly of the hedge trimmer in accordance with embodiments of the present disclosure;

FIG. 4A is a partial exploded view of an assembly of the hedge trimmer in accordance with embodiments of the present disclosure;

FIG. 4B is an exploded view of the assembly of the hedge trimmer of FIG. 4A in accordance with embodiments of the present disclosure;

FIG. 5A is a cross-sectional view of housing of the hedge trimmer in accordance with embodiments of the present disclosure;

FIG. 5B is an exploded view of the housing of the hedge trimmer of FIG. 5A in accordance with embodiments of the present disclosure;

FIG. 6 is a perspective view of a crankshaft of the hedge trimmer in accordance with embodiments of the present disclosure;

FIG. 7 is a detailed view of a blade assembly of the hedge trimmer in accordance with embodiments of the present disclosure;

FIG. 8 is a perspective view of a fastener of the blade assembly of FIG. 7 in accordance with embodiments of the present disclosure;

FIG. 9 is a top view of a blade of the blade assembly 700 of FIG. 7 in accordance with embodiments of the present disclosure;

FIG. 10A is a perspective view of a blade assembly in a locked state of the hedge trimmer in accordance with embodiments of the present disclosure;

FIG. 10B is a perspective view of the blade assembly FIG. 10A in an unlocked state of the hedge trimmer in accordance with embodiments of the present disclosure;

FIG. 10C is an exploded view of the blade assembly of FIG. 10A in accordance with embodiments of the present disclosure;

FIG. 10D is a cross-sectional view of the blade assembly of FIG. 10A in accordance with embodiments of the present disclosure;

FIG. 11A is a schematic diagram of an assembly of the hedge trimmer in a locked state in accordance with embodiments of the present disclosure;

FIG. 11B is a schematic diagram of the assembly of the hedge trimmer of FIG. 11A in an unlocked state in accordance with embodiments of the present disclosure;

FIG. 12A is a cross-sectional view of a housing of the hedge trimmer in accordance with embodiments of the present disclosure;

FIG. 12B is a top, cross-sectional view of the housing of the hedge trimmer of FIG. 12A in accordance with embodiments of the present disclosure;

FIG. 13 is a schematic diagram of a blade assembly of the hedge trimmer in accordance with embodiments of the present disclosure;

FIG. 14 is a schematic diagram of a blade assembly of the hedge trimmer in accordance with embodiments of the present disclosure;

FIG. 15 is a perspective view of a blade assembly of the hedge trimmer in accordance with embodiments of the present disclosure; and

FIG. 16 is a perspective, interior view of a housing of the hedge trimmer in accordance with embodiments of the present disclosure.

FIG. 17 is a schematic view of a control system in accordance with embodiments of the present disclosure.

FIG. 18 is a flow chart of a method of operating a hedge trimmer in accordance with embodiment of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises.” “comprising,” “includes.” “including.” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present). A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, an outdoor power tool in accordance with one or more embodiments described herein may generally include improved blade replacement capabilities. Additionally, one or more embodiments of the outdoor power tool described herein may detect a blade type of one or more blades coupled to the outdoor power tool.

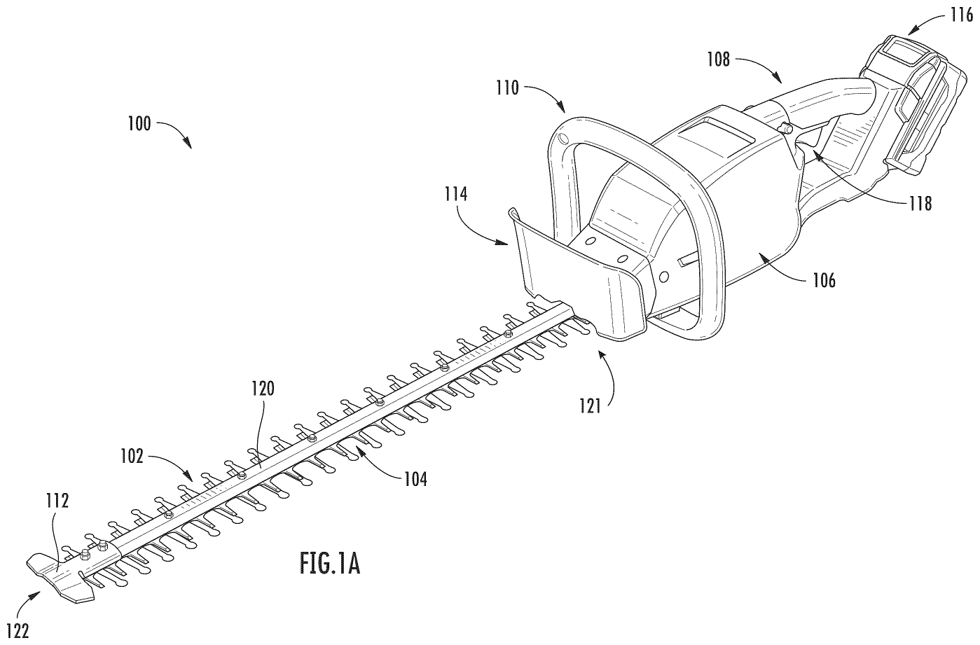

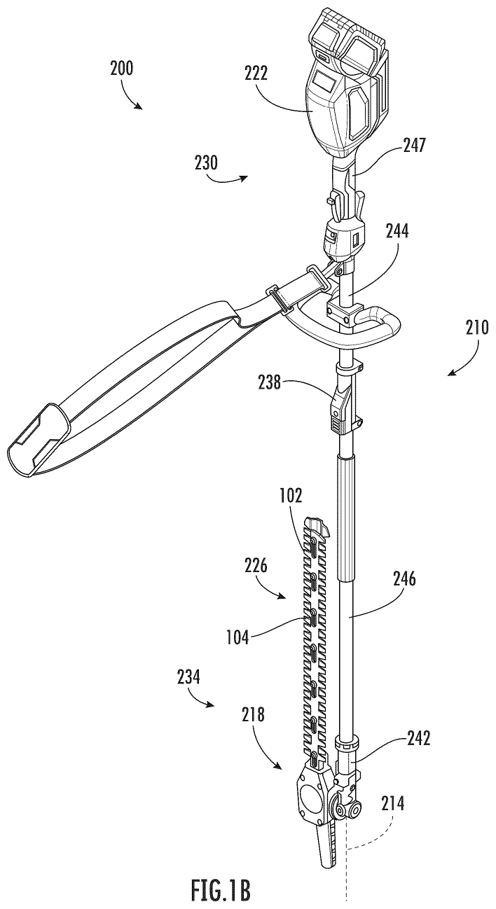

Referring now to the drawings, FIG. 1A illustrates an outdoor power tool in accordance with an exemplary embodiment of the present disclosure. More particularly, FIG. 1A illustrates a hedge trimmer 100 in accordance with an embodiment of the present disclosure. The hedge trimmer 100 generally includes at least one reciprocating cutting implement. For example, the hedge trimmer 100 may include a first blade 102 and a second blade 104 extending from a first end 121 to a second end 122 opposite the first end 121. The first blade 102 and the second blade 104 include “teeth” which, when the implements are reciprocated, cause the blades to cut into material, such as branches of hedges. In other example embodiments, only one of the first blade 102 and the second blade 104 are configured to reciprocate. For example, one of the first blade 102 and the second blade 104 may remain stationary while the other of the first blade and the second blade 104 reciprocates to cause the blades to cut into the material.

The hedge trimmer 100 may further include a housing 106. The first blade 102 and the second blade 104 may extend from the housing 106. Moreover, the first blade 102 and the second blade 104 of the hedge trimmer 100 be coupled to a spine 120 extending from the housing 106 for supporting the first blade 102 and the second blade 104. The hedge trimmer 100 may include a handle 108. In some example embodiments, the hedge trimmer 100 may further include a secondary handle 110. The hedge trimmer 100 may further include a blade tip guard 112. The blade tip guard 112 may be coupled to a portion of the spine 120 adjacent the second end 122 and configured to prevent the blades located furthest from the housing 106 from contact with objects (e.g., fences, siding, etc.). The hedge trimmer 100 may further include a blade guard 114. Blade guard 114 may be configured to stop flying debris from hitting the operator.

The hedge trimmer 100 may also include a motive device (not shown) such as an electric motor or gas powered engine, which drives a crankshaft (not shown). The crankshaft may be engaged with the first blade 102 and the second blade 104 such that rotation of the crankshaft causes the first blade 102 and the second blade 104 to reciprocate. The motive device may be powered, for example, by a rechargeable energy source such as a battery 116, a fuel source such as gasoline, or the like. In the depicted example embodiment, the hedge trimmer 100 includes an actuator 118. The actuator 118 is disposed proximate to the handle 108. When depressed, the actuator 118 may engage the motive device to cause the first blade 102 and the second blade 104 to move. As the actuator 118 is depressed further, a speed of the motive device can increase from zero speed to a maximum speed. In this regard, the actuator 118 may variably affect the speed of the motive device between a stopped speed, which occurs when the actuator 118 is not depressed, and a maximum speed, which occurs when the actuator 118 is fully depressed.

FIG. 1B illustrates an outdoor power tool or pole tool, such as a hedge trimmer 200, for use in performing outdoor tasks such as trimming hedges. The hedge trimmer 200 includes an elongated shaft assembly 210 extending along a shaft axis 214, a trimmer head 218 at one end of the shaft assembly 210, and a powerhead 222 at an opposite end of the shaft assembly 210. The trimmer head 218 includes a blade assembly 226 for performing trimming. For example, the blade assembly 226 may include the first blade 102 and the second blade 104 as discussed with respect to FIG. 1A. The powerhead 222 generates a motive force to drive the blade assembly 226 during operation of the hedge trimmer 200.

As shown in FIG. 1B, the hedge trimmer 200 includes a powerhead unit 230 and a tool portion or attachment unit 234 (e.g., a hedge trimmer attachment, a string trimmer attachment, a pole saw attachment, etc., including, e.g., a tool end, an operating tool, a tool portion, etc.) selectively and removably coupled to the powerhead unit 230 via first and second connecting portions 238, 242. In the embodiment depicted, the attachment unit 234 is a hedge trimmer attachment. The shaft assembly 210 includes first and second shaft segments 244, 246. The powerhead unit 230 includes the powerhead 222 with an 2operator's handle 247, the first shaft segment 244, and the connecting portion 238. The attachment unit 234 includes the trimmer head 218, the second shaft segment 246, and the second connecting portion 242. In other example embodiments (not shown), the hedge trimmer 200 is a standalone tool so that the trimmer head 218 and the powerhead 222 are not separable.

A first driveshaft segment is disposed within and extends axially within the first shaft segment 244 along the shaft axis 214. The first driveshaft segment is drivingly coupled to the powerhead 222. A second driveshaft segment is disposed within and extends axially within the second shaft segment 46. The second driveshaft segment is drivingly coupled to the trimmer head 218. When the attachment unit 234 is attached to the powerhead unit 230, the first driveshaft segment couples to the second driveshaft segment to drivingly transmit rotary power from the powerhead 222 to the trimmer head 218.

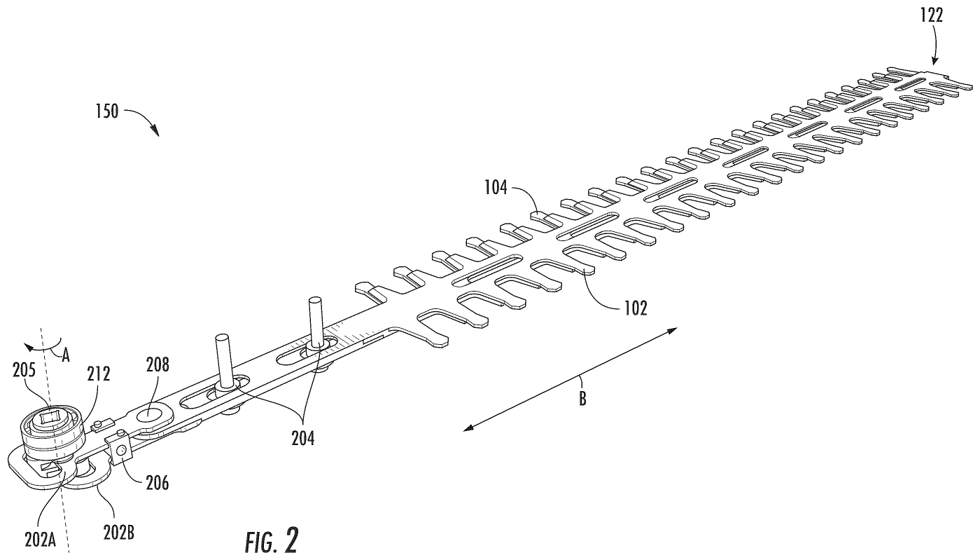

FIG. 2 is a perspective view of a blade assembly 150 in accordance with embodiments of the present disclosure. The blade assembly 150 may be incorporated into the hedge trimmer 100 shown in FIG. 1A and/or incorporated into the hedge trimmer 200 as the blade assembly 226 shown in FIG. 1B.

In at least one example embodiment, the blade assembly 150 connects the first blade 102 and the second blade 104 to a crankshaft 205. The blade assembly 150 may generally include one or more connecting rods 202A and 202B. Reference made hereinafter to the connecting rods 202 may refer to one or more of the first and second connecting rods 202A or 202B unless specified to the contrary. Connecting rods 202 may extend between the first blade 102 and the second blade 104 and the crankshaft 205. In an example embodiment, the blade assembly 150 may include two connecting rods 202 each coupled to one of the first blade 102 or the second blade 104. One or more guides 204 may guide the first blade 102 and the second blade 104 to move in a generally reciprocating manner. A bushing 206 (e.g., a split bushing) may support and guide at least one of the connecting rods 202, or the first blade 102 or the second blade 104. In an example embodiment, the connecting rods 202 may be coupled to the first blade 102 and the second blade 104 through a pin 208. In another example embodiment, the blade assembly 150 may include one or more bearings coupled to the crankshaft 205. The crankshaft 205 may rotate about a vertical axis 212 in a direction indicated by arrow A. As the crankshaft 205 rotates, the first blade 102 and the second blade 104 may translate in a direction indicated by arrow B.

FIG. 3 is a perspective view of an assembly of the hedge trimmer in accordance with embodiments of the present disclosure. More particularly, FIG. 3 illustrates a cartridge assembly 300 for the hedge trimmer 200 illustrated in FIG. 1B.

In at least one example embodiment, the cartridge assembly 300 includes a crankshaft cartridge, such as a first cartridge 303, and a blade cartridge, such as a second cartridge 305. For example, the first cartridge 303 may include an attachment member 310 for coupling the first cartridge 303 to the housing of the trimmer head 218, shown in FIG. 1B. The first cartridge 303 also includes a first cartridge housing 315 coupled to and extending from the attachment member 310. The first cartridge housing 315 may include a crankshaft (not shown), such as the crankshaft 205, configured to be mechanically coupled to the motive device of the hedge trimmer 200. The second cartridge 305 may include a second cartridge housing 320. The second cartridge housing 320 may be removably couplable to the first cartridge housing 315 of the first cartridge 303. As shown in FIG. 3, the first blade 102 and the second blade 104 may be at least partially disposed within and extend from the second cartridge housing 320. Moreover, one or more engagement members (not shown) may be disposed within the second cartridge housing 320 for driving the first blade 102 and the second blade 104. For example, the second cartridge housing 320 may be coupled to the first cartridge housing 315 such that the crankshaft is mechanically coupled to the one or more engagement members for translating rotational motion of the crankshaft to linear motion of the one or more engagement members for driving the reciprocating motion of the first blade 102 and the second blade 104.

The first cartridge 303 and the second cartridge 305 may provide a modular system for replacing the first blade 102 and the second blade 104 of the hedge trimmer 100. Moreover, replacing one or both of the first cartridge 303 and the second cartridge 305 enables a gear ratio change, a blade speed change, a stroke change, an inertia change, and a blade geometry change of the hedge trimmer 200. Moreover, the first cartridge 303 and/or the second cartridge 305 may be coupled to the housing 106 and to each other by one or more fasteners. For example, the one or more fasteners may include captured nuts and screws, one-quarter turn locked, cam lock fasteners, or a combination thereof. Additionally, a tool may be disposed within or coupled to the hedge trimmer 200 for removing and securing the first cartridge 303 and/or the second cartridge 305 to the hedge trimmer 200. For example, the tool may include a hex key or a scrench. A scrench typically include multiple types of tools combined into a single unit. For example, a scrench may include a screwdriver and one or more wrench sockets. While the first cartridge 303 and the second cartridge 305 have been discussed with respect to the hedge trimmer 200, it should be understood that the first cartridge 303 and the second cartridge 305 may be utilized with other power tools, such as pole tools including pole saws, string trimmers, edgers, for example.

In other example embodiments, the cartridge assembly 300 may be incorporated into the hedge trimmer 100 shown in FIG. 1A. For example, the attachment member 310 may be removably coupled to or disposed within the housing 106.

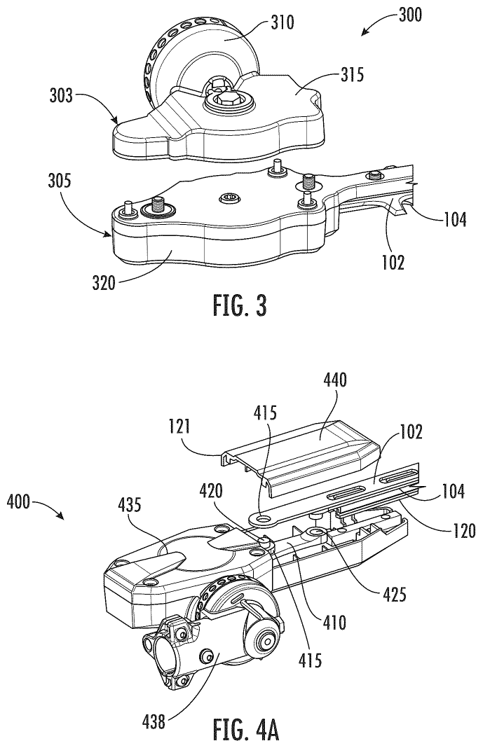

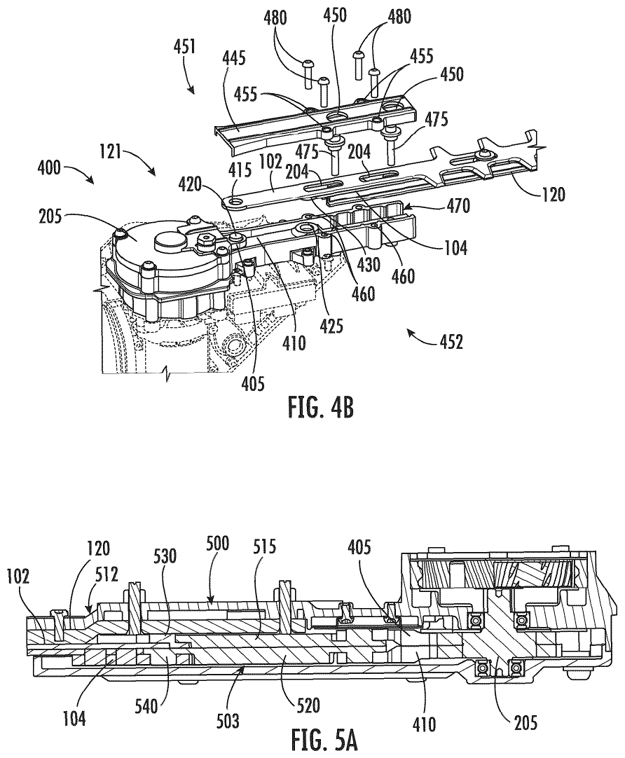

FIG. 4A is a partial exploded view of an assembly of the hedge trimmer 200 in accordance with embodiments of the present disclosure. FIG. 4B is an exploded view of the assembly of the hedge trimmer 200 of FIG. 4A in accordance with embodiments of the present disclosure. More specifically, FIGS. 4A-4B illustrate a housing 400 of the trimmer head 218 of the hedge trimmer 200 shown in FIG. 1B. In other example embodiments, the housing 400 may be incorporated into the housing 106 of the hedge trimmer 100 shown in FIG. 1A.

In at least one example embodiment, the housing 400 includes a crankshaft 205. The crankshaft 205 may engage the first blade 102 and the second blade 104 via a first connecting rod 405 and a second connecting rod 410. The first connecting rod 405 and the second connecting rod may be similar or analogous to the first connecting rod 202A and the second connecting rod 202B discussed with respect to FIG. 2. The first connecting rod 405 is coupled to the crankshaft 205 and configured to drive the first blade 102, and the second connecting rod 410 is coupled to the crankshaft 205 and configured to drive the second blade 104. For example, the first blade 102 may define a first opening 415 adjacent the first end 121 configured to receive a first protrusion 420 extending from the first connecting rod 405 such that the first blade 102 is removably secured to the first connecting rod 405. Additionally, the second connecting rod 410 may define a second opening 425 configured to receive a second protrusion 430 extending from a surface of the second blade 104 adjacent the first end 121 such that the second blade 104 is removably secured to the second connecting rod 410. Accordingly, the first blade 102, the second blade 104, the first connecting rod 405, and the second connecting rod 410 are configured to at least partially extend from the housing 400. Additionally, a sleeve 438 may be coupled to the housing 400 for receiving the second shaft segment 245 of the shaft assembly 210, as shown in FIG. 1B.

The first connecting rod 405 has a first length and the second connecting rod 410 has a second length different from the first length. In at least one example embodiment, the second length is greater than the first length. In other example embodiments, the first length may be greater than the second length. The different lengths allow the first connecting rod 405 and the second connecting rod 410 to be offset, which may improve serviceability and replacement of the first blade 102 and the second blade 104.

Moreover, the first connecting rod 405 has a first weight and the second connecting rod 410 has a second weight different than the first weight. In at least one example embodiment, the first weight is less than the second weight. In other example embodiments, the first weight may be greater than the second weight. The different weights of the first connecting rod 405 and the second connecting rod 410 provides counterbalancing, which may reduce vibrations.

With reference to FIG. 4A, the housing 400 may include a first cover 435 and a second cover 440. The first cover 435 may be removably coupled to the housing 400 and configured to cover the crankshaft 205 and at least a portion of the first connecting rod 405 and the second connecting rod 410. The first cover 435 may also cover at least a portion of the first blade 102 and the second blade 104 adjacent the first end 121. The second cover 440 may be removably coupled to the housing 400 and configured to cover at least a portion of the first connecting rod 405 and the second connecting rod 410 extending from the first cover 435. The second cover 440 may also cover at least a portion of the first blade 102 and the second blade 104. The first cover 435 and the second cover 440 may be coupled to the housing 400 with one or more fasteners, such as bolts and clips, via rails, or via a friction fit. Including a separate cover for covering the crankshaft 205 (the first cover 435) allows the crankshaft 205 to remain greased, untouched, and protected while another cover (the second cover 440) may be separately removed for removal and replacement of the first blade 102 and the second blade 104.

With reference to FIG. 4B, where the first cover 435 and the second cover 440 are removed for illustrative purposes, the first blade 102, the second blade 104, and the spine 120 may be coupled to the crankshaft 205 of the housing 400 with an attachment plate 445. The attachment plate 445 may define a first set of openings 450 disposed in a central portion of the attachment plate 445 and a second set of openings 455 disposed adjacent peripheral edges of the attachment plate 445. The first set of openings 450 may be aligned with the one or more guides 204 of the first blade 102 and the second blade 104. Accordingly, a number of the first set of openings 450 may be the same as a number of the one or more guides 204. The first set of openings 450 and the one or more guides 204 may be configured to receive a first set of fasteners 475. The first set of fasteners 475 may be configured to secure the first blade 102, the second blade 104, and the spine 120 to the attachment plate 445 while still allowing the first blade 102 and the second blade 104 to move in a reciprocating manner via the one or more guides 204. The first set of fasteners 475 may include screws, bolts, pins, or other fasteners for securing the first blade 102, the second blade 104, and the spine 120 to the attachment plate 445.

The second set of openings 455 may be disposed adjacent to one or both of a first side 451 and a second side 452 opposite the first side 451 of the housing 400. For example, as shown in FIG. 4B, the second set of openings 455 includes one or more openings disposed adjacent the first side 451 and one or more openings disposed adjacent the second side 452. Moreover, the second set of openings 455 may be disposed in one or more regions extending from peripheral edges of the attachment plate 445. The one or more openings 455 may be aligned with one or more base openings 460 disposed in a base portion 465 of the housing 400. For example, a number of the one or more openings 455 may be the same as a number of the second set of openings 455. Moreover, the base portion 465 may define a recess 470 for at least partially receiving the first connecting rod 405, the second connecting rod 410, the first blade 102, the second blade 104, and the spine 120. The second set of openings 455 of the attachment plate 445 and the one or more base openings 460 of the base portion 465 may be configured to receive a second set of fasteners 480 for securing the attachment plate 445 to the base portion 465. The second set of fasteners 480 may include screws, bolts, pins, or other fasteners for securing t the attachment plate 445 to the base portion 465. Accordingly, the attachment plate 445 is configured to cover the recess 470 and secure the first blade 102, the second blade 104, and the spine 120 within the recess 170 of the base portion 465.

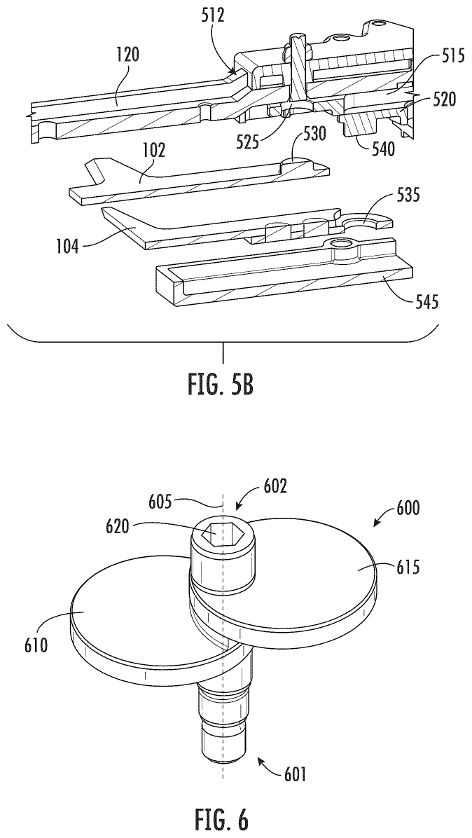

FIG. 5A is a cross-sectional view of a housing 500 of the exemplary hedge trimmer 100, 200 in accordance with embodiments of the present disclosure. FIG. 5B is an exploded view of the housing 500 of FIG. 5A in accordance with embodiments of the present disclosure. The housing 500 may be incorporated into the housing 106 of the hedge trimmer 100 and/or the housing of the trimmer head 218 of the hedge trimmer 200.

In at least one example embodiment, the housing 500 includes the crankshaft 205 mechanically coupled to the first blade 102 and the second blade 104. The housing 500 may also include a link assembly 503 for mechanically coupling the first blade 102 and the second blade 104 to the crankshaft 205 via the first connecting rod 405 and the second connecting rod 410. Moreover, the link assembly 503 includes a first link 515 and a second link 520. The first link 515 is coupled between the first connecting rod 405 and the first blade 102, and the second link 520 is coupled between the second connecting rod 410 and the second blade 104. As shown in FIGS. 5A-5B, the spine 120 may include a bent portion 512 for providing space within the housing 500 for the first link 515 and the second link 520.

The first link 515 defines a link opening 525 for receiving a blade protrusion 530 extending from a surface of the first blade 102. The blade protrusion 530 may be removably inserted into the link opening 525 for removably coupling the first blade 102 to the first link 515. The second blade 104 defines a blade opening 535 for receiving a link protrusion 540 extending from a surface of the second link 520. The second blade 104 may be removably coupled to the second link 520 via the blade opening 535 and the link protrusion 540.

With reference to FIG. 5B, the housing 500 may include a removable housing portion 545. The removably housing portion 545 may be removed from the housing 500 to provide access to the first blade 102 and the second blade 104 such that the first blade 102 and the second blade 104 may be removed from the first link 515 and the second link 520, respectively, and replaced.

FIG. 6 is a perspective view of a crankshaft 600 in accordance with embodiments of the present disclosure. The crankshaft 600 may be incorporated into the exemplary hedge trimmer 100, 200. Moreover, the crankshaft 600 may be similar or analogous to the crankshaft 205.

In at least one example embodiment, the crankshaft 600 extends along a crankshaft axis 605 between a first end 601 and a second end 602. The first end 601 of the crankshaft 600 may be configured to be mechanically coupled to the motive device of the hedge trimmer 100, 200 for driving rotation of the crankshaft 600 about the crankshaft axis 605. The crankshaft 600 includes a first cam 610 and a second cam 615 opposite the first cam 610. The first cam 610 and the second cam 615 are configured to translate rotational motion of the crankshaft 600 to reciprocating, linear motion of the first blade 102 and the second blade 104 during operation of the hedge trimmer 100, 200.

As shown in FIG. 6, the second end 602 of the crankshaft 600 may define an opening 620. In at least one example embodiment, the opening 620 includes a hexagonal shape. In other example embodiments, the opening 620 may have any polygonal shape.

The opening 620 may be configured to receive a tool for rotating the crankshaft 600. For example, the tool may be configured to rotate the crankshaft 600 via the opening 620 in order to align or offset the first blade 102 and the second blade 104 via the first cam 610 and the second cam 615 such that the first blade 102 and the second blade 104 may be accessed for removal. In at least one example embodiment, the tool includes, a scrench, a hex tool, a screwdriver, or any other tool or engaging the opening 620 and rotating the crankshaft 600.

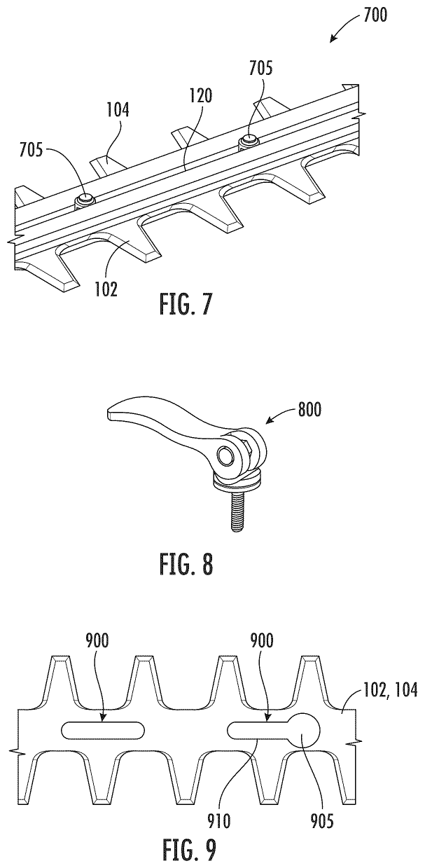

FIG. 7 is a detailed view of a blade assembly 700 of the exemplary hedge trimmer 100, 200 in accordance with embodiments of the present disclosure. FIG. 8 is a perspective view of a fastener of the blade assembly 700 of FIG. 7 in accordance with embodiments of the present disclosure. FIG. 9 is a top view of a blade of the blade assembly 700 of FIG. 7 in accordance with embodiments of the present disclosure.

The blade assembly 700 may be similar or analogous to the exemplary blade assembly 150 of the hedge trimmer 100 and the exemplary blade assembly 226 of the hedge trimmer 200. For example, the blade assembly 700 includes the spine 120 coupled to the first blade 102 and the second blade 104. The spine 120 may be couped to the first blade 102 and the second blade 104 with one or more fasteners 705. As shown in FIG. 7, the one or more fasteners 705 may include screws, nuts, bolts, or a combination thereof. Additionally, or alternatively, the one or more fasteners 705 may include one or more cam-lock fasteners, such as the exemplary cam-lock fastener shown in FIG. 8. Moreover, the hedge trimmer 100, 200 may include an onboard tool, such as a hex key or scrench, for removing the one or more fasteners 704 and securing the one or more fasteners 705 to the spine 120, the first blade 102, and the second blade 104.

With reference to FIG. 9, the first blade 102 and the second blade 104 may define a plurality of slots 900 spaced apart along a length of the first blade 102 and the second blade 104. The plurality of slots 900 are configured to receive the one or more fasteners 705. In at least one example embodiment, one or more of the plurality of slots 900 may include a keyhole. For example, one or more of the plurality of slots 900 may include a first portion 905 and a second portion 910 extending from the first portion 905. The second portion 910 may be an elongated slot extending from the first portion 905. The first portion 905 may also have a larger diameter than the second portion 910. Accordingly, the one or more fasteners 705 may be inserted through the first portion 905 and slid axially into the second portion 910 for securing the first blade 102 and the second blade 104 to the spine 120. Similarly, to remove the first blade 102 and the second blade 104 from the spine 120, the one or more fasteners 705 may slide axially from the second portion 910 to the first portion 905 for removal through the first portion 905.

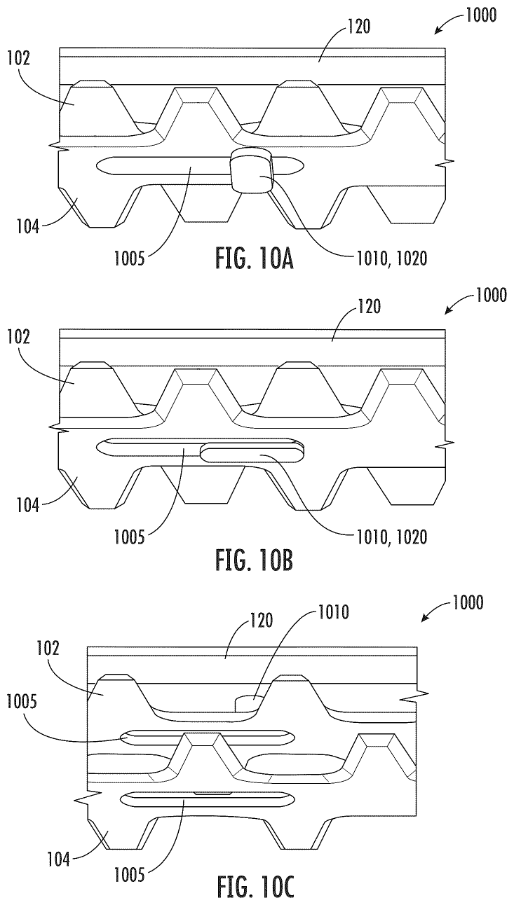

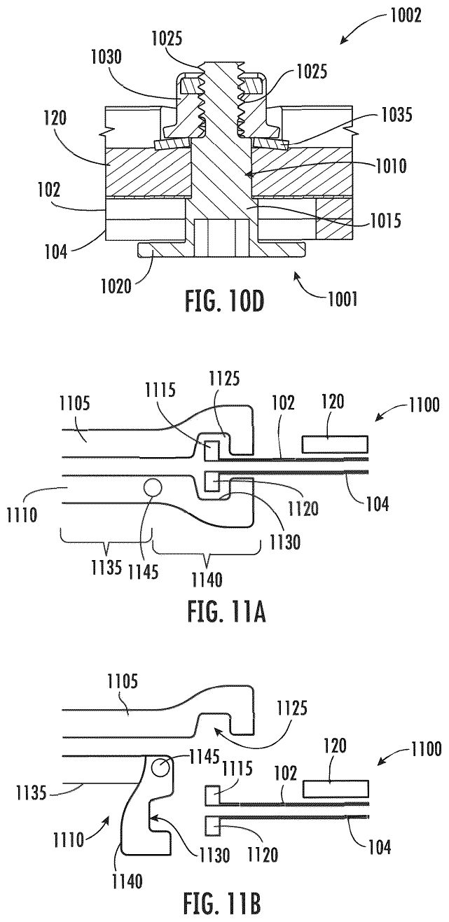

FIG. 10A is a perspective view of a blade assembly 1000 of the exemplary hedge trimmer 100, 200 in a locked state in accordance with embodiments of the present disclosure. FIG. 10B is a perspective view of the blade assembly 1000 of FIG. 10A in an unlocked state in accordance with embodiments of the present disclosure. FIG. 10C is an exploded view of the blade assembly 1000 of FIG. 10A in accordance with embodiments of the present disclosure. FIG. 10D is a cross-sectional view of the blade assembly 1000 of FIG. 10A in accordance with embodiments of the present disclosure.

The blade assembly 1000 may be similar or analogous to the exemplary blade assembly 150, 226, 700 discussed above. For example, the blade assembly 1000 includes the spine 120 coupled to the first blade 102 and the second blade 104. The spine 120 may be couped to the first blade 102 and the second blade 104 with one or more fasteners 1010. Moreover, the first blade 102 and the second blade 104 define a plurality of elongated slots 1005 spaced along a length of the first blade 102 and the second blade 104 for receiving the one or more fasteners 1010.

In at least one example embodiment, the one or more fasteners 1010 may include quarter-turn fasteners. For example, as shown in FIG. 10D, the one or more fasteners 1010 may include a base portion 1015 extending between a first end 601 and a second end 1002. The base portion 1015 is configured to be inserted through the plurality of elongated slots 1005 of the first blade 102 and the second blade 104. The base portion 1015 is also configured to be inserted into a corresponding opening defined in the spine 120. The first end 601 of the one or more fasteners 1010 may include an elongated face 1020 extending perpendicular to the base portion 1015 and configured to be adjacent to an exterior surface of the first blade 102 and/or the second blade 104. The second end 602 of the one or more fasteners 1010 is configured to be adjacent to and extend from an exterior surface of the spine 120. The second end 602 of the one or more fasteners 1010 may include a plurality of threads 1025 for engaging a nut 1030 for securing the one or more fasteners 1010 to the spine 120, the first blade 102, and the second blade 104. Moreover, the one or more fasteners 1010 may include a washer 1035 at least partially disposed between the spine 120 and the nut 1030.

One or both of the elongated face 1020 and the base portion 1015 of the one or more fasteners 1010 are configured to rotate relative to the nut 1030. For example, one or both of the elongated face 1020 and the base portion 1015 may be configured to rotate at least 90°. Moreover, one or both of the elongated face 1020 and the base portion 1015 are configured to rotate between a locked position, shown in FIG. 10A, and an unlocked position, shown in FIG. 10B. In the locked position shown in FIG. 10A, the elongated face 1020 may extend perpendicular to a length of the plurality of elongated slots 1005 such that the one or more fasteners 1010 secure the first blade 102 and the second blade to the spine 120. In the unlocked position shown in FIG. 10B, the elongated face 1020 may extend parallel with the length of the plurality of elongated slots 1005 such that the first blade 102 and the second blade 104 may be removed from the one or more fasteners 1010 and the spine 120, as shown in FIG. 10C.

FIG. 11A is a schematic diagram of a blade assembly 1100 of the exemplary hedge trimmer 100, 200 in a locked state in accordance with embodiments of the present disclosure. FIG. 11B is a schematic diagram of the blade assembly 1100 of FIG. 11A in an unlocked state in accordance with embodiments of the present disclosure.

The blade assembly 1100 may be similar or analogous to the exemplary blade assembly 150, 226, 700, 1000 discussed above. For example, the blade assembly 1100 includes the spine 120 coupled to the first blade 102 and the second blade 104. Additionally, the first blade 102 and the second blade 104 are coupled to a first connecting rod 1105 and a second connecting rod 1110. The first connecting rod 1105 and the second connecting rod 1110 may be similar or analogous to the first connecting rod 202A, 405 and the second connecting rod 202B, 410 discussed with respect to FIGS. 2 and 4A-4B.

In at least one example embodiment, the first blade 102 includes a first protrusion 115 extending perpendicular to a length of the first blade 102 and configured to engage the first connecting rod 1105. The second blade 104 includes a second protrusion 1120 extending perpendicular to a length of the second blade 104 and configured to engage the second connecting rod 1110. For example, the first connecting rod 1105 defines a first recess 1125 for receiving the first protrusion 1115 of the first blade 102 and the second connecting rod 1110 defines a second recess 1130 for receiving the second protrusion 1120 of the second blade 104.

In at least one example embodiment, the second connecting rod 1110 includes a first rod segment 1135 and a second rod segment 1140. The second rod segment 1140 may define the second recess 1130 and is configured to engage the second blade 104. Moreover, the second rod segment 1140 is pivotally coupled to the first rod segment at a hinged joint 1145. For example, the second rod segment 1140 is configured to pivot relative to the first rod segment 1135 between an engaged position, shown in FIG. 11A, and a disengaged position, shown in FIG. 11B. Accordingly, the first blade 102 and the second blade 104 may be secured to the hedge trimmer 100, 200 in the engaged position, and the first blade 102 and the second blade 104 may be removed and replaced in the disengaged position.

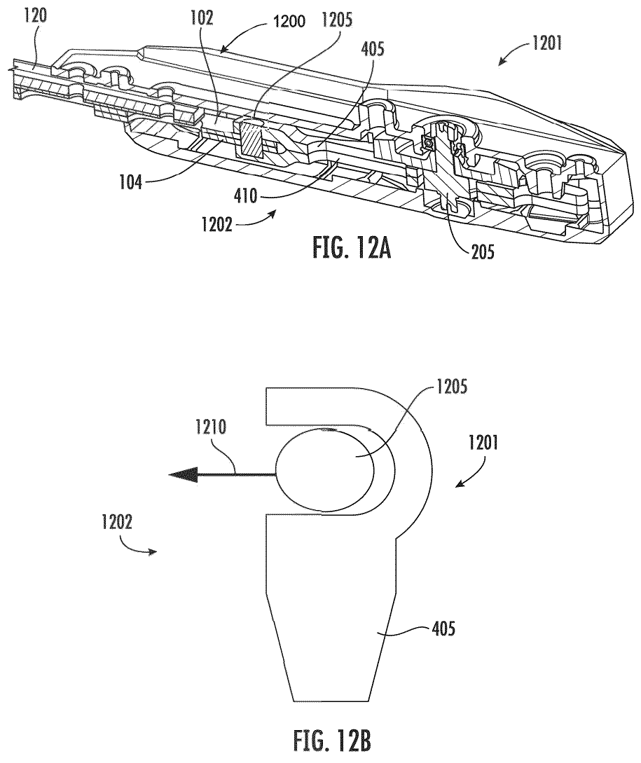

FIG. 12A is a cross-sectional view of a housing 1200 of the hedge trimmer 100, 200 in accordance with embodiments of the present disclosure. FIG. 12B is a top, cross-sectional view of the housing 1200 of FIG. 12A in accordance with embodiments of the present disclosure. For example, the housing 1200 may be incorporated into the exemplary hedge trimmer 100 as the housing 106 and the housing 1200 may be incorporated into the exemplary hedge trimmer 200 as a housing of the trimmer head 218.

In at least one example embodiment, the housing 1200 includes the crankshaft 205, the first connecting rod 405 configured to be coupled to the first blade 102, and the second connecting rod 410 configured to be coupled to the second blade 104. As shown in FIG. 12A, at least a portion of the spine 120 may also be disposed within the housing 1200.

In at least one example embodiment, each of the first connecting rod 405, the second connecting rod 410, the first blade 102, and the second blade 104 define openings configured to be aligned with each other within the housing 1200. A blade pin 1205 may be inserted into the openings of the first connecting rod 405, the second connecting rod 410, the first blade 102, and the second blade 104 to secure the first blade 102 and the second blade 104 to the first connecting rod 405 and the second connecting rod 410 within the housing 1200.

The housing 1200 includes a first side 1201 and a second side 1202 opposite the first side. In at least one example embodiment, the housing 1200 may include a removable side cover (not shown) configured to engage the first side 1201 of the housing. Upon removal of the side cover, an interior portion of the housing 1200 may be exposed, as shown in FIG. 12A. For example, the blade pin 1205 may be exposed and accessed for removal, as shown in FIG. 12B. After removal of the blade pin 1205, the first blade 102 and the second blade 104 may be slid or removed from the second side 1202 of the housing 1200, as indicated by arrow 1210. Additionally, the first blade 102 and the second blade 104 may be replaced through the second side 1202 of the housing 1200, the blade pin 1205 may be replaced, and the side cover (not shown) may be coupled to the housing 1200 adjacent the second side 1202.

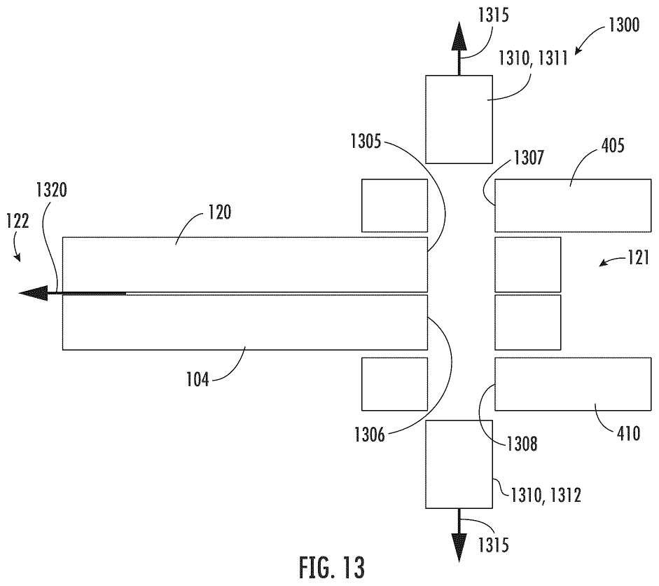

FIG. 13 is a schematic diagram of a blade assembly 1300 of the exemplary hedge trimmer 100, 200 in accordance with embodiments of the present disclosure.

As shown in FIG. 13, the blade assembly 1300 includes the first blade 102 and the second blade 104, and the first connecting rod 405 and the second connecting rod for coupling the first blade 102 and the second blade 104 to the crankshaft 205 (FIG. 2). In at least one example embodiment, the first blade 102 defines a first blade opening 1305, the second blade 104 defines a second blade opening 1306, the first connecting rod 405 defines a first rod opening 1307, and the second connecting rod 410 defines a second rod opening 1308. The first blade opening 1305, the second blade opening 1306, the first rod opening 1307 and the second rod opening 1308 are configured to be aligned adjacent the first end 121 of the first blade 102 and the second blade 104, as shown in FIG. 13. Moreover, the first blade opening 1305, the second blade opening 1306, the first rod opening 1307, and the second rod opening 1308 are configured to be aligned to receive at least one pin 1310. The at least one pin 1310 is configured to secure the first blade 102 and the second blade 104 to the first connecting rod 405 and the second connecting rod 410, respectively.

In some example embodiments, the at least one pin 1310 may include two pins, as shown in FIG. 13. For example, the at least one pin 1310 may include a first pin 1311 for insertion through the first rod opening 1307 of the first connecting rod 405 and the first blade opening 1305 of the first blade 102 and a second pin 1312 for insertion through the second rod opening 1308 of the second connecting rod 410 and the second blade opening 1306 of the second blade 104. The first pin 1311 and the second pin 1312 may be removed from the first blade opening 1305, the second blade opening 1306, the first rod opening 1307, and the second rod opening 1308, as indicated by arrows 1315, such that the first blade 102 and the second blade 104 may be removed from the first connecting rod 405 and the second connecting rod 410, as indicated by arrow 1320.

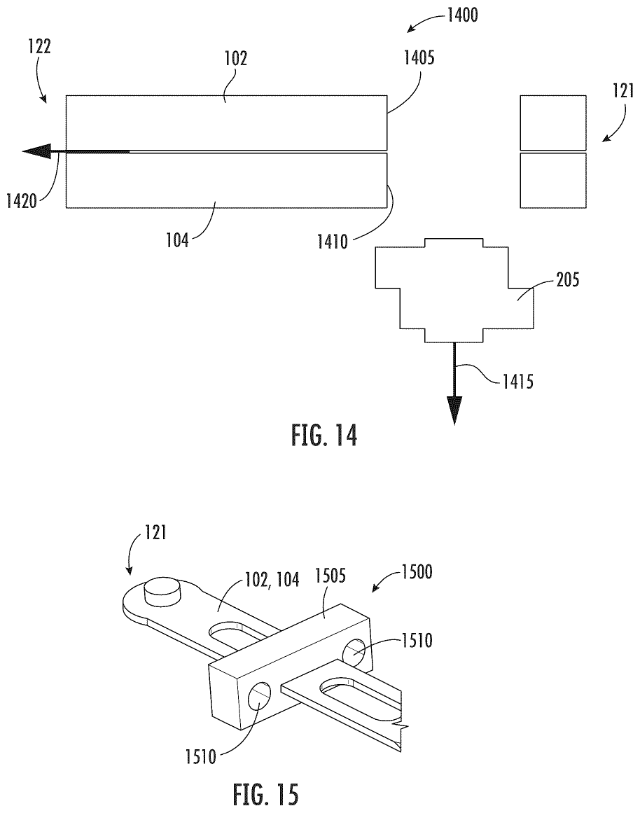

FIG. 14 is a schematic diagram of a blade assembly 1400 of the hedge trimmer 100, 200 in accordance with embodiments of the present disclosure.

The blade assembly 1400 includes he first blade 102, the second blade 104, and the crankshaft 205. As shown in FIG. 14, the first blade 102 and the second blade 104 may be directly coupled to the crankshaft 205, such as without the intervening first connecting rod 405 and the second connecting rod 410 shown in FIG. 13. In such example embodiments, the first blade 102 defines a first blade opening 1405 and the second blade 104 defines a second blade opening 1410. The first blade opening 1405 and the second blade opening 1410 may be configured to removably receive the crankshaft 205. As shown in FIG. 14, removal of the crankshaft 205 from the first blade opening 1405 and the second blade opening 1410, as indicated by arrow 1415, allows the first blade 102 and the second blade 104 to be removed from the hedge trimmer 100, 200, as indicated by arrow 1420.

FIG. 15 is a perspective view of a blade assembly 1500 of the hedge trimmer 100, 200 in accordance with embodiments of the present disclosure.

In at least one example embodiment, one or both of the first blade 102 and the second blade 104 may include a plate 1505 adjacent the first end 121 of the first blade 102 and the second blade 104. The plate 1505 defines one or more openings 1510 for receiving one or more fasteners for securing the first blade 102 and/or the second blade 104 to the crankshaft 205 (FIG. 2). Additionally, or alternatively, the one or more openings 1510 may receive one or more fasteners for securing the first blade 102 and/or the second blade 104 to the first connecting rod 202A, 405 and the second connecting rod 202B, 410.

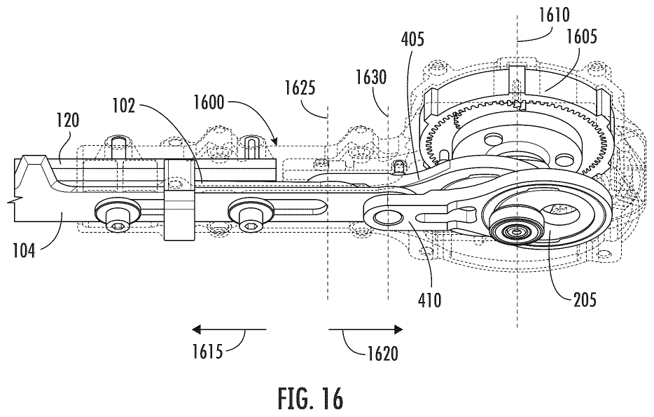

FIG. 16 is a perspective, interior view of a housing 1600 of the hedge trimmer 100, 200 in accordance with embodiments of the present disclosure.

In at least one example embodiment, a motor 1605 is disposed within the housing 1600 and mechanically coupled to the crankshaft 205. The first connecting rod 405 and the second connecting rod 410 are disposed in the housing 1600 and coupled to the crankshaft 205. Moreover, the first blade 102 and the second blade 104 are coupled to the first connecting rod 405 and the second connecting rod 410, respectively, and extend from the housing 1600.

The motor 1605 is configured to rotate the crankshaft 205 about a rotational axis 1610. Rotational motion of the crankshaft 205 is translated into linear motion of the first connecting rod 405 and the second connecting rod 410 for translating such linear or reciprocating motion to the first blade 102 and the second blade 104. For example, the first connecting rod 405, the second connecting rod 410, the first blade 102, and the second blade 104 are reciprocated in a first direction 1615 and a second direction 1612 opposite the first direction 1615. Moreover, the first direction 1615 and the second direction 1620 are transverse or perpendicular to the rotational axis 1610.

In at least one example embodiment, an actuator, such as the actuator 118 shown in FIG. 1A, is electrically coupled to the motor 1605 for selectively activating and deactivating the motor 1605. For example, depressing the actuator may activate the motor 1605, causing the first blade 102 and the second blade 104 to move, and releasing the actuator may deactivate the motor 1605. Upon release of the actuator, the motor 1605 may rotate such that the first blade 102 and the first connecting rod 405 are in a desired position or offset relative to the second blade 104 and the second connecting rod 410. For example, a first axis 1625 may extend through a connecting point of the first blade 102 and the first connecting rod 405, and a second axis 1630 may extend through a connecting point of the second blade 104 and the second connecting rod 410. As shown in FIG. 16, the desired position may be the first axis 1625 forward of the second axis 1630 when the actuator is released. In other example embodiments, the desired position may be the second axis 1630 forward of the first axis 1625.

Offsetting the first blade 102 and the second blade 104, and thus the first connecting rod 405 and the second connecting rod 410, when the actuator is released may place the first blade 102 and the second blade 104 in position for removal and replacement. Moreover, in the event that the hedge trimmer 100, 200 stalls during operation, the actuator may be depressed then released to align the blades in the desired, offset position.

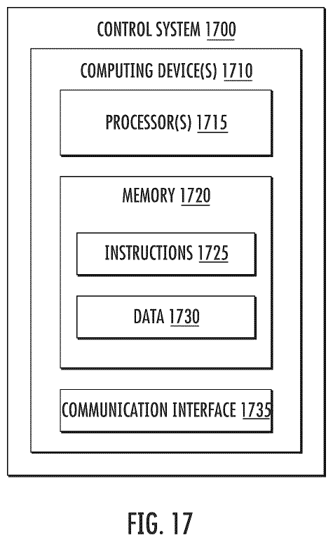

FIG. 17 is a schematic view of a control system 1700 in accordance with embodiments of the present disclosure.

In at least one example embodiment, the hedge trimmer 100, 200 includes the control system 1700. For example, the control system 1700 may be disposed within the housing 106 of the hedge trimmer 100, and the control system 1700 may be disposed in the powerhead 222 and/or the trimmer head 218 of the hedge trimmer 200. Moreover, the control system 1700 may be configured to control operation of the motive device of the hedge trimmer 100, 200. For example, the control system 1700 may control operation of the motor 1605 as discussed with respect to FIG. 16 above.

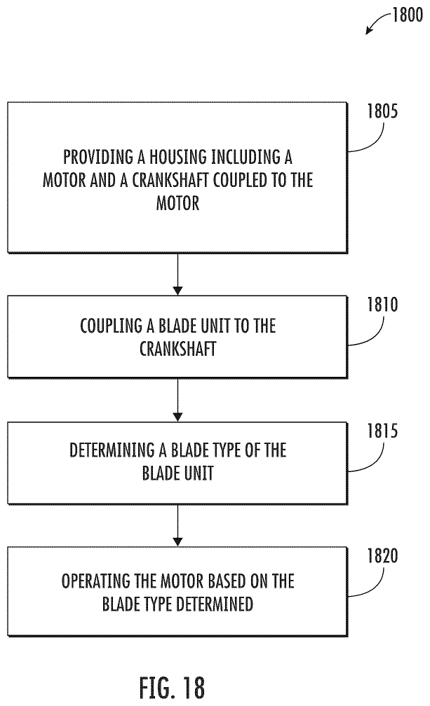

The control system 1700 can include one or more computing device(s) 1710. The computing device(s) 1710 may be configured to execute one or more methods in accordance with exemplary aspects of the present disclosure (such as method 1800 described below with reference to FIG. 18). The computing device(s) 1710 can include one or more processor(s) 1715 and one or more memory device(s) 1720. The one or more processor(s) 1715 can include any suitable processing device, such as a microprocessor, microcontroller, integrated circuit, logic device, or other suitable processing device. The one or more memory device(s) 1720 can include one or more computer-readable media, including, but not limited to, non-transitory computer-readable media, RAM, ROM, hard drives, flash drives, or other memory devices.

The one or more memory device(s) 1720 can store information accessible by the one or more processor(s) 1715, including computer-readable instructions 1725 that can be executed by the one or more processor(s) 1715. The instructions 1725 can be any set of instructions that when executed by the one or more processor(s) 1715, cause the one or more processor(s) 1715 to perform operations. The instructions 1725 can be software written in any suitable programming language or can be implemented in hardware. In some example embodiments, the instructions 1725 can be executed by the one or more processor(s) 1715 to cause the one or more processor(s) 1715 to perform operations, such as the operations for controlling the motive device, as described herein, and/or any other operations or functions of the one or more computing device(s) 1710. Additionally, and/or alternatively, the instructions 1725 can be executed in logically and/or virtually separate threads on the one or more processor(s) 1715. The memory device(s) 1720 can further store data 1730 that can be accessed by the one or more processor(s) 1715.

The computing device(s) 1710 can also include a communications interface 1735 used to communicate, for example, with the components of the hedge trimmer 100, 200, such as the actuator, the motive device, and/or other computing device(s) 1710. The communications interface 1735 can include any suitable components for interfacing with these components or one or more communications network(s), including for example, transmitters, receivers, ports, controllers, antennas, wired communication buses, or other suitable components. For example, the communications interface 1735 may be in communication with an external device via a wired or wireless connection. The external device may include a mobile phone, computer, laptop, tablet, or other device. The control system 1700 may also be in communication (e.g., via communications interface 1735) with various sensors and may selectively operate the motive device of the hedge trimmer 100, 200 in response to user input and feedback from these sensors.

The technology discussed herein makes reference to computer-based systems and actions taken by and information sent to and from computer-based systems. It should be appreciated that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

FIG. 18 is a flow chart of a method 1800 of operating a power tool in accordance with embodiment of the present disclosure. More specifically, FIG. 18 illustrates the method 1800 of operating the hedge trimmer 100, 200.

In at least one example embodiment, the method 1800 includes providing a housing including a motor and a crankshaft coupled to the motor at 1805, coupling a blade unit to the crankshaft at 1810, determining a blade type of the blade unit at 1815, and operating the motor based on the blade type determined at 1820.

Providing a housing including a motor and a crankshaft coupled to the motor at 1805 may include providing the housing 106 including a motive device or motor of the hedge trimmer 100, as discussed with respect to FIG. 1A. Providing a housing including a motor and a crankshaft coupled to the motor at 1805 may also include providing the powerhead 222 and/or the trimmer head 218 of the hedge trimmer 200, as discussed with respect to FIG. 1B. The crankshaft may include the crankshaft 205 discussed with respect to FIGS. 2-6 and 16. Moreover, coupling a blade unit to the crankshaft at 1810 may include coupling the first blade 102 and the second blade 104 to the crankshaft 205, as discussed with respect to FIGS. 2-16. The blade unit may include the first blade 102 and the second blade 104.

In at least one example embodiment, determining a blade type of the blade unit at 1815 includes detecting an amount of power consumed by the motor, detecting a speed, such as a rotational speed, of the motor, and identifying the blade type of the first blade 102 and/or the second blade 104 based on the amount of power consumed by the motor and the speed of the motor. In some example embodiments, determining a blade type of the blade unit at 1815 includes detecting a voltage of the blade unit including the first blade 102 and the second blade 104. For example, the hedge trimmer 100, 200 may provide a set voltage, a ground signal, and a return signal to the blade unit. The blade unit includes a set of resistors and returns a blade unit voltage to the return signal. The voltage of the blade unit may allow the hedge trimmer 100, 200, such as via the control system 1700, to identify the blade type of the blade unit connected to the hedge trimmer 100, 200.

In additional example embodiments, determining a blade type of the blade unit at 1815 includes identifying the blade type based pull-up resistors of the blade unit, pull-down resistors of the blade unit, or a combination thereof. For example, the hedge trimmer 100, 200 provides a series of connections to the blade unit including voltage, ground, and one or more address signals. The blade unit may use pull-up and/or pull-down resistors to configure the one or more address signals to allow the hedge trimmer 100, 200 to identify the blade type of the first blade 102 and the second blade 104 of the blade unit.

In still additional example embodiments, the blade unit may include a radio frequency identification (RFID) tag and the hedge trimmer 100, 200 may include a near field communication (NFC) circuit communicatively coupled to the control system 1700. In such embodiments, determining a blade type of the blade unit at 1815 may include receiving the blade type from the RFID tag via the NFC.

Further aspects of the disclosure are provided by one or more of the following embodiments:

An outdoor power tool, comprising: a first blade extending from a first end to a second end; a second blade extending from the first end to the second end; a first connecting rod coupled to the first blade at the first end and comprising a first length; a second connecting rod coupled to the second blade at the first end and comprising a second length different from the first length; and a crankshaft coupled to the first connecting rod and the second connecting rod for transmitting reciprocating motion to the first blade, the second blade, or both the first blade and the second blade in a first direction and a second direction, the second direction opposite the first direction.

The outdoor power tool of any one or more of the embodiments, further comprising: a crankshaft cartridge including the crankshaft; and a blade cartridge, wherein the first blade, the second blade, the first connecting rod, and the second connecting rod are at least partially disposed within the blade cartridge; wherein the blade cartridge is removably couplable to the crankshaft cartridge.

The outdoor power tool of any one or more of the embodiments, wherein the first length is greater than the second length.

The outdoor power tool of any one or more of the embodiments, wherein the second length is greater than the first length.

The outdoor power tool of any one or more of the embodiments, wherein a first weight of the first connecting rod is greater than a second weight of the second connecting rod.

The outdoor power tool of any one or more of the embodiments, wherein a first weight of the first connecting rod is less than a second weight of the second connecting rod.

The outdoor power tool of any one or more of the embodiments, further comprising: a housing including the crankshaft, wherein the first connecting rod, the second connecting rod, the first blade, and the second blade at least partially extend from the housing; a first cover removably coupled to the housing, the first cover configured to cover the crankshaft and at least a portion of the first connecting rod and the second connecting rod; and a second cover removably coupled to the housing adjacent the first cover and configured to cover at least a portion of the first connecting rod, the second connecting rod, the first blade, and the second blade.

The outdoor power tool of any one or more of the embodiments, further comprising: a first link coupled between the first blade and the first connecting rod; and a second link coupled between the second blade and the second connecting rod; wherein the first link defines a link opening for receiving a blade protrusion extending from a surface of the first blade adjacent the first end; and wherein the second blade defines a blade opening for receiving a link protrusion extending from a surface of the second link.

The outdoor power tool of any one or more of the embodiments, further comprising a spine for supporting the first blade and the second blade, wherein the first blade and the second blade define one or more slots; and wherein the first blade and the second blade are coupled to the spine with one or more fasteners extending through the one or more slots.

The outdoor power tool of any one or more of the embodiments, wherein the one or more fasteners includes screws, nuts, bolts, or a combination thereof.

The outdoor power tool of any one or more of the embodiments, wherein the one or more fasteners includes one or more cam-lock fasteners.

The outdoor power tool of any one or more of the embodiments, wherein the one or more fasteners includes one or more one-quarter turn fasteners.

The outdoor power tool of any one or more of the embodiments, further comprising a scrench, hex key, or tool for disengaging the one or more fasteners and removing one or both of the first blade and the second blade from the spine.

The outdoor power tool of any one or more of the embodiments, wherein the crankshaft defines an opening for receiving a tool for rotating the crankshaft.

The outdoor power tool of any one or more of the embodiments, wherein: the second connecting rod comprises a first rod segment configured to engage the first end of the second blade, a second rod segment engaging the crankshaft, and a hinged joint connecting the first rod segment and the second rod segment; the second rod segment is configured to pivot about the hinged joint between an engaged position and a disengaged position; the second rod segment secures the first blade and the second blade in the engaged position; and the first blade and the second blade may be removed in the disengaged position.

The outdoor power tool of any one or more of the embodiments, further comprising: a housing including the crankshaft, wherein the first connecting rod, the second connecting rod, the first blade, and the second blade at least partially extend from the housing; and a side cover removably coupled to the housing, wherein removal of the side cover from the housing exposes the crankshaft, the first connecting rod, the second connecting rod, the first blade, and the second blade.

The outdoor power tool of any one or more of the embodiments, wherein: the first blade defines a first opening adjacent the first end; the second blade defines a second opening adjacent the first end; the first connecting rod defines a first rod opening; the second connecting rod defines a second rod opening; the first opening, the second opening, the first rod opening, and the second rod opening are aligned; and the first opening, the second opening, the first rod opening, and the second rod opening are configured to removably receive at least one pin for securing the first blade and the second blade to the first connecting rod and the second connecting rod.

The outdoor power tool of any one or more of the embodiments, wherein: the first blade defines a first opening adjacent the first end; the second blade defines a second opening adjacent the first end, the second opening aligned with the first opening; and the first opening and the second opening are configured to removably receive the crankshaft.

The outdoor power tool of any one or more of the embodiments, wherein the first blade and the second blade comprise a plate adjacent the first end, the plate defines one or more openings for receiving one or more fasteners for securing the first blade and the second blade to the crankshaft.

The outdoor power tool of any one or more of the embodiments, wherein the first blade and the second blade are slidably coupled together by a bushing spaced apart from the crankshaft.

The outdoor power tool of any one or more of the embodiments, wherein the first connecting rod and the second connecting rod are configured to convert rotational motion of the crankshaft about a rotational axis to linear motion of the first blade and the second blade.

The outdoor power tool of any one or more of the embodiments, further comprising a motor coupled to the crankshaft, the motor configured to rotate the crankshaft about a rotational axis, wherein the first direction and the second direction are transverse to the rotational axis; wherein the first connecting rod and the second connecting rod are configured to convert rotational motion of the crankshaft about the rotational axis to linear motion of the first blade and the second blade.

The outdoor power tool of any one or more of the embodiments, further comprising an actuator electrically coupled to the motor for selectively activating and deactivating the motor; wherein releasing the actuator such that the motor is deactivated moves the first blade and the second blade to a deactivation position such that the first blade extends past the second blade.

The outdoor power tool of any one or more of the embodiments, wherein the outdoor power tool is a hedge trimmer.

The outdoor power tool of any one or more of the embodiments, further comprising: a powerhead including a motor configured to be coupled to the crankshaft; a housing including the crankshaft, the first connecting rod, and the second connecting rod, the first blade and the second blade configured to at least partially extend from the housing; and an elongated shaft extending between the powerhead and the housing.

A method of operating an outdoor power tool, comprising: providing a housing including a motor and a crankshaft coupled to the motor; coupling a blade unit including a first blade and a second blade to the crankshaft; determining a blade type of the first blade and the second blade; and operating the motor based on the blade type.

The method of any one or more of the embodiments, wherein operating the motor comprises translating the first blade and the second blade in a first direction and a second direction opposite the first direction.

The method of any one or more of the embodiments, wherein determining the blade type comprises: detecting an amount of power consumed by the motor; detecting a speed of the motor; and identifying the blade type based on the amount of power consumed by the motor and the speed of the motor.

The method of any one or more of the embodiments, wherein determining the blade type comprises detecting a voltage of the blade unit.

The method of any one or more of the embodiments, wherein determining the blade type comprises identifying the blade type based on pull-up resistors of the blade unit, pull-down resistors of the blade unit, or a combination thereof.

The method of any one or more of the embodiments, wherein the blade unit comprises a radio frequency identification (RFID) tag, and wherein determining the blade type comprises receiving the blade type from the RFID tag via a near field communication (NFC) circuit.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An outdoor power tool, comprising:
a first blade extending from a first end to a second end;
a second blade extending from the first end to the second end;
a first connecting rod coupled to the first blade at the first end and comprising a first length;
a second connecting rod coupled to the second blade at the first end and comprising a second length different from the first length; and
a crankshaft coupled to the first connecting rod and the second connecting rod for transmitting reciprocating motion to the first blade, the second blade, or both the first blade and the second blade in a first direction and a second direction, the second direction opposite the first direction.

2. The outdoor power tool of claim 1, further comprising:
a crankshaft cartridge including the crankshaft; and
a blade cartridge, wherein the first blade, the second blade, the first connecting rod, and the second connecting rod are at least partially disposed within the blade cartridge;
wherein the blade cartridge is removably couplable to the crankshaft cartridge.

3. The outdoor power tool of claim 1, wherein:
the first length is greater than the second length; and
a first weight of the first connecting rod is greater than a second weight of the second connecting rod.

4. The outdoor power tool of claim 1, further comprising:
a housing including the crankshaft, wherein the first connecting rod, the second connecting rod, the first blade, and the second blade at least partially extend from the housing;
a first cover removably coupled to the housing, the first cover configured to cover the crankshaft and at least a portion of the first connecting rod and the second connecting rod; and
a second cover removably coupled to the housing adjacent the first cover and configured to cover at least a portion of the first connecting rod, the second connecting rod, the first blade, and the second blade.

5. The outdoor power tool of claim 1, further comprising:
a first link coupled between the first blade and the first connecting rod; and
a second link coupled between the second blade and the second connecting rod;
wherein the first link defines a link opening for receiving a blade protrusion extending from a surface of the first blade adjacent the first end; and
wherein the second blade defines a blade opening for receiving a link protrusion extending from a surface of the second link.

6. The outdoor power tool of claim 1, further comprising:
a spine for supporting the first blade and the second blade, wherein the first blade and the second blade define one or more slots; and wherein the first blade and the second blade are coupled to the spine with one or more fasteners extending through the one or more slots; and
a scrench, hex key, or tool for disengaging the one or more fasteners and removing one or both of the first blade and the second blade from the spine.

7. The outdoor power tool of claim 6, wherein the one or more fasteners includes screws, nuts, bolts, one or more cam-lock fasteners, one or more one-quarter turn fasteners, or a combination thereof.

8. The outdoor power tool of claim 1, wherein the crankshaft defines an opening for receiving a tool for rotating the crankshaft.

9. The outdoor power tool of claim 1, wherein:
the second connecting rod comprises a first rod segment configured to engage the first end of the second blade, a second rod segment engaging the crankshaft, and a hinged joint connecting the first rod segment and the second rod segment;
the second rod segment is configured to pivot about the hinged joint between an engaged position and a disengaged position;
the second rod segment secures the first blade and the second blade in the engaged position; and
the first blade and the second blade may be removed in the disengaged position.

10. The outdoor power tool of claim 1, further comprising:
a housing including the crankshaft, wherein the first connecting rod, the second connecting rod, the first blade, and the second blade at least partially extend from the housing; and
a side cover removably coupled to the housing, wherein removal of the side cover from the housing exposes the crankshaft, the first connecting rod, the second connecting rod, the first blade, and the second blade.

11. The outdoor power tool of claim 1, wherein:
the first blade defines a first opening adjacent the first end;
the second blade defines a second opening adjacent the first end;
the first connecting rod defines a first rod opening;
the second connecting rod defines a second rod opening;
the first opening, the second opening, the first rod opening, and the second rod opening are aligned; and
the first opening, the second opening, the first rod opening, and the second rod opening are configured to removably receive at least one pin for securing the first blade and the second blade to the first connecting rod and the second connecting rod.

12. The outdoor power tool of claim 1, wherein:
the first blade defines a first opening adjacent the first end;
the second blade defines a second opening adjacent the first end, the second opening aligned with the first opening; and
the first opening and the second opening are configured to removably receive the crankshaft.

13. The outdoor power tool of claim 1, wherein the first blade and the second blade comprise a plate adjacent the first end, the plate defines one or more openings for receiving one or more fasteners for securing the first blade and the second blade to the crankshaft.

14. The outdoor power tool of claim 1, further comprising:
a motor coupled to the crankshaft, the motor configured to rotate the crankshaft about a rotational axis, wherein the first direction and the second direction are transverse to the rotational axis, wherein the first connecting rod and the second connecting rod are configured to convert rotational motion of the crankshaft about the rotational axis to linear motion of the first blade and the second blade; and
an actuator electrically coupled to the motor for selectively activating and deactivating the motor, wherein releasing the actuator such that the motor is deactivated moves the first blade and the second blade to a deactivation position such that the first blade extends past the second blade.

15. A method of operating an outdoor power tool, comprising:
providing a housing including a motor and a crankshaft coupled to the motor;
coupling a blade unit including a first blade and a second blade to the crankshaft;
determining a blade type of the first blade and the second blade; and
operating the motor based on the blade type.

16. The method of claim 15, wherein operating the motor comprises translating the first blade and the second blade in a first direction and a second direction opposite the first direction.

17. The method of claim 15, wherein determining the blade type comprises:
detecting an amount of power consumed by the motor;
detecting a speed of the motor; and
identifying the blade type based on the amount of power consumed by the motor and the speed of the motor.

18. The method of claim 15, wherein determining the blade type comprises detecting a voltage of the blade unit.

19. The method of claim 15, wherein determining the blade type comprises identifying the blade type based on pull-up resistors of the blade unit, pull-down resistors of the blade unit, or a combination thereof.

20. The method of claim 15, wherein the blade unit comprises a radio frequency identification (RFID) tag, and wherein determining the blade type comprises receiving the blade type from the RFID tag via a near field communication (NFC) circuit.
